(19) United States
(12) Patent Application Publication
(10) Pub. No.: US 2025/0273941 A1
(43) Pub. Date: Aug. 28, 2025

(54) ADJUSTABLE ELECTRICAL BOX

(71) Applicant: ERICO International Corporation, Solon, OH (US)

(72) Inventors: Michael Hung-Sun Oh, Twinsburg, OH (US); Raymond M. Olle, Valley View, OH (US); James Anthony Bukowski, Akron, OH (US)

(21) Appl. No.: 19/065,505

(22) Filed: Feb. 27, 2025

Related U.S. Application Data
(60) Provisional application No. 63/558,734, filed on Feb. 28, 2024.

(51) Int. Cl. H02G 3/08; H02G 3/12

(52) U.S. Cl. CPC H02G 3/081; H02G 3/12

(57) ABSTRACT

An assembly for an adjustable-depth electrical box can include a housing with outer sidewalls that slidably receive an extendable sleeve. A first housing tab may extend integrally from a first outer sidewall. A first hole may be disposed in the first outer sidewall, adjacent the first housing tab, and a first cover may close the first hole. An extendable sleeve including sleeve walls and a first sleeve tab may be provided. The outer sidewalls may slidably receive an extendable sleeve. An adjustment fastener may extend through the first housing tab and may be rotatable to adjust a depth of the extendable sleeve relative to the housing.

### CROSS-SECTION TO RELATED APPLICATIONS

This application claims priority to and incorporates by reference U.S. Provisional Patent Application No. 63/558,734, filed Feb. 28, 2024.

### BACKGROUND

In many applications, it may be useful to support electrical boxes at different depths relative to support structures, including ceiling or wall structures of buildings.

### SUMMARY

Some embodiments of the invention provide an adjustable-depth electrical box assembly. The assembly may include an adjustable-depth electrical box that can include a housing. The housing may include outer sidewalls extending from a base end to an open end of the housing, including a first outer sidewall. A first housing tab may extend integrally from the first outer sidewall, with a first hole disposed in the first outer sidewall, adjacent the first housing tab. The assembly may further include an extendable sleeve with sleeve walls and a first sleeve tab, where the outer sidewalls can slidably receive the extendable sleeve. A first cover may contact an exterior of the first outer sidewall, closing the first hole. An adjustment fastener may extend through the first housing tab and the first sleeve tab and may be rotatable to adjust a depth of the extendable sleeve relative to the housing.

Some embodiments of the invention provide an adjustable-depth electrical box assembly. The assembly may include an adjustable-depth electrical box that can include a housing. The housing may include outer sidewalls extending from a base end to an open end of the housing, including a first outer sidewall. A first housing tab may be stamped from the first outer sidewall. A first hole may be resultant from the stamping of the first housing tab. A first cover plate may contact the first outer sidewall, closing the first hole. The assembly may further include an extendable sleeve and a fastener extending through the first housing tab to adjust the extendable sleeve relative to the housing.

Some embodiments of the invention provide a method of assembling an adjustable-depth electrical box. In some embodiments, the method may include forming a housing with a housing tab integrally formed with a sidewall of the housing. The method may include closing a hole disposed adjacent the housing tab with a cover contacting the housing. The method may include aligning an extendable sleeve to be inserted into the housing so that the housing tab is aligned with a sleeve tab of the extendable sleeve. The method may include installing an adjustment fastener to extend through the housing tab and the sleeve tab to adjust the extendable sleeve relative to the housing.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of an electrical box assembly, with an adjustable-depth electrical box in a partially extended position according to an embodiment of the invention;

FIG. 2 is an axonometric view of an embodiment of a housing and an extendable sleeve of the electrical box assembly of FIG. 1;

FIG. 3 is an axonometric view of the housing of the electrical box assembly of FIG. 2;

FIG. 4 is a front elevation view of the housing of the electrical box assembly of FIG. 2;

FIG. 5 is a cross-sectional view of the electrical box assembly of FIG. 4, taken at V-V;

FIG. 6 is an axonometric view of an embodiment of a housing of the electrical box assembly of FIG. 1, including a first example of a cover plate;

FIG. 7 is a front elevation view of an electrical box FIG. 6, including the cover plate;

FIG. 8 is a cross-sectional view of the electrical box of FIG. 7, taken at VIII-VIII;

FIG. 9 is an axonometric view of an embodiment of a housing of the electrical box assembly of FIG. 1, including a second example of the cover plate;

FIG. 10 is a front elevation view of the housing of FIG. 9;

FIG. 11 is a cross-sectional view of the housing of FIG. 10, taken at XI-XI;

FIG. 12 is a front elevation view of an embodiment of the electrical box assembly of FIG. 1, including a housing and a centerplate;

FIG. 13 is an axonometric view of the housing and centerplate of FIG. 12;

FIG. 14A is a cross-sectional view of the housing and centerplate of FIG. 12, taken at XIV-XIV;

FIG. 14B is a partial detail view of FIG. 14A;

FIG. 15A is an axonometric view of an embodiment of a housing and centerplate of the electrical box assembly of FIG. 1;

FIG. 15B an axonometric view of a portion of the centerplate of the electrical box assembly of FIG. 1

FIG. 16A is a cross-sectional view of the housing and centerplate of FIG. 15, taken at XVI-XVI;

FIG. 16B is a partial detail view of FIG. 16A;

FIG. 17A is an axonometric view of an electrical box assembly according to an embodiment of the invention; and

FIG. 17B is a front elevation view of the electrical box assembly of FIG. 17A.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, in some contexts, it may be useful to support electrical boxes at different depths relative to relevant building structures. In this regard, an electrical box having an adjustable extension may provide flexibility for installers. For example, in some installations an electrical box assembly may need to be arranged with a front opening of an electrical box flush with an exterior surface of a wall or ceiling structure (e.g., drywall, tile, etc.). However, other portions of an electrical box assembly may need to be engaged with a building support structure (e.g., a stud, support bracket, ceiling structure, etc.) at a depth that can vary between different sites or installations. Further in this regard, it can sometimes be difficult to precisely space a support structure relative to the relevant surfaces of drywall or ceiling tile. For example, the relevant support structure may be offset from the interior surface of the drywall or ceiling at an undesirable distance (e.g., too far away) relative to a depth of a fixed-depth electrical box. It may accordingly be beneficial to install an adjustable electrical box having an adjustably extendable component, so as to be able to selectively extend or retract the extendable component of the electrical box to comply with relevant spacing (or other) requirements.

Correspondingly, embodiments of the invention can provide an electrical box and associated assembly or method that can allow easy adjustment of an extension of an electrical box relative to a support structure, including after the electrical box has been installed on the support structure. Examples of the present invention may accordingly save time and money during installation and provide for improved service configurations, including by allowing installers to simply adjust the extension of the electrical box itself to accommodate the needs of a particular installation. Some examples can be used with assemblies having far side supports (e.g., with masonry-box or other assemblies configured to be secured directly to a stud). Some examples can be used with assemblies having no far side supports (e.g., with light-fixture or other assemblies configured to be secured with a between-stud bracket).

Generally, embodiments of the invention can include an electrical box assembly configured to support electrical components (e.g., low voltage devices or other known electrical devices, etc.). The electrical box assembly may be secured to one or more other structures directly or indirectly, including in various in-wall and overhead applications (e.g., with direct mounting to studs or ceiling, or with indirect mounting via brackets supports on studs or T-grid ceiling members). The electrical box assembly may be adjusted to a desired alignment, including to be flush with a visible surface in a building (e.g., wall or ceiling surfaces of various types, including drywall and ceiling tiles, etc.). Thus, some examples can be flexibly used with support structures that have a wide range of distances from a relevant surface (e.g., of exposed drywall).

The electrical box assembly may include an electrical box with a housing and an extendable sleeve nested within the housing. The extendable sleeve may be configured to be translationally adjusted relative to the housing along an axis that is transverse to the base of the housing. The extendable sleeve can be coupled to the electrical box housing with fasteners. Generally, in this regard, adjustment of the fasteners can adjust an extension of the extendable sleeve in an axial direction defined by the fasteners, relative to the electrical box housing.

In some embodiments, it may be useful to arrange the extendable sleeve and the housing so that the fasteners are disposed within an interior of the electrical box. For example, a set of housing tabs extending into the housing may receive and retain the fasteners. Conventionally, housing tabs can be affixed to the electrical box using a variety of coupling techniques (e.g., spot welding, a threaded fastener, or other related coupling technique). In such embodiments, it can be important to properly align the housing tabs with corresponding sleeve tabs disposed on the extendable sleeve, also configured to receive and retain the fasteners. However, present methods for securing the housing tabs to the housing can be inaccurate, leading to possible misalignment of the housing tabs of the housing and the sleeve tabs of the extendable sleeve. Such misalignment can potentially lead to damaged (e.g., stripped) adjustment fasteners, improper extension of the electrical box, and other issues.

In some embodiments, in order to rectify issues regarding misalignment of the housing tabs and the sleeve tabs, the housing tabs may be formed integrally with the sidewall(s) of the housing. For example, the housing tab(s) can be stamped or otherwise cut from the sidewall(s) of the housing, and bent to an operational orientation. Utilizing a process such as stamping to form the housing tabs with the sidewalls of the housing can increase positional precision and accuracy, leading to less issues regarding misalignment of the housing and sleeve tabs (e.g., as compared to welding).

During the process of integrally forming the housing tabs from the sidewalls of the housing, one or more holes may be created in the sidewalls. In some embodiments, it may be advantageous to close or cover the holes using a cover plate. As will be described below, the hole(s) can be closed using cover(s) (e.g., cover plates) secured directly to the electrical box, or by cover(s) secured to a centerplate of the electrical box assembly. Furthermore, in some embodiments, it may be advantageous to position the cover on an exterior surface of the housing. As will be described below, positioning the cover on an exterior surface of the housing may advantageously reduce the chance of the cover obstructing components within the housing. Additionally, positioning the cover on an exterior surface of the housing may advantageously allow the cover to be easily installed and to more easily cover an entire hole resultant from the stamping of the housing tab.

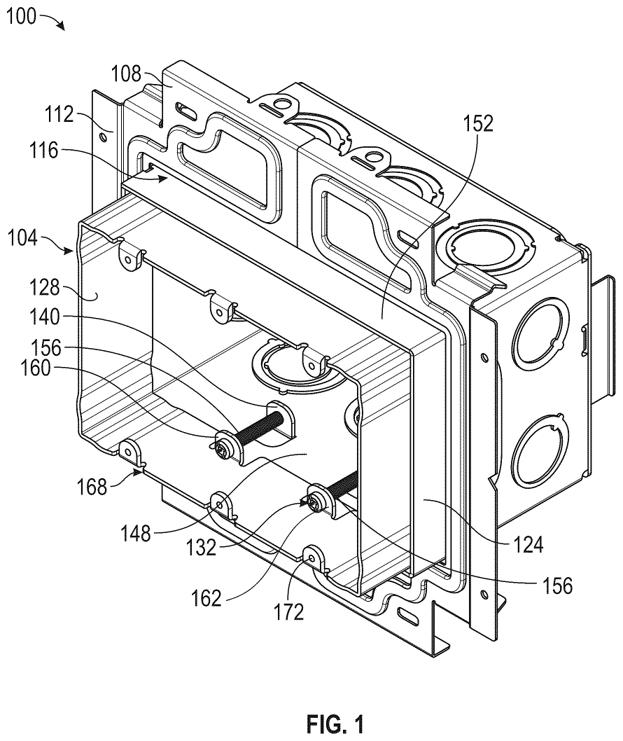

Referring to FIG. 1, an example electrical box assembly 100 is shown according to an embodiment of the invention. In the illustrated example, the electrical box assembly 100 includes an electrical box 104 (shown here as a rectangular electrical box) and a centerplate 108. The centerplate 108 has a plate body 112 with a plate opening 116 configured to receive the electrical box 104 therein and therethrough. As shown in FIG. 1, the plate opening 116 is sized and configured to closely follow the rectangle shape of the electrical box 104. This can provide for stable support of the electrical box and reliable installation. In other embodiments, however, other mounting brackets (e.g., other centerplates) may be used, including other on- or between-stud brackets variously known in the art. Further, some box assemblies may not include any similar bracket (e.g., may include only an adjustable-depth electrical box).

FIG. 1. illustrates an example electrical box assembly 100 according to an embodiment of the invention. The electrical box assembly 100 may be secured to a support structure (e.g., a wall or ceiling structure), including using between-stud or other brackets of various known types (not shown). The electrical box assembly 100 may be used to secure one or more electrical components (e.g., light fixtures, low voltage devices, or other electrical devices of various known types (not shown)), from the support structure (not shown). The electrical box assembly 100 may further house one or more conductors (not shown), arranged for electrical connection to the relevant electrical devices or other devices exterior to the assembly 100.

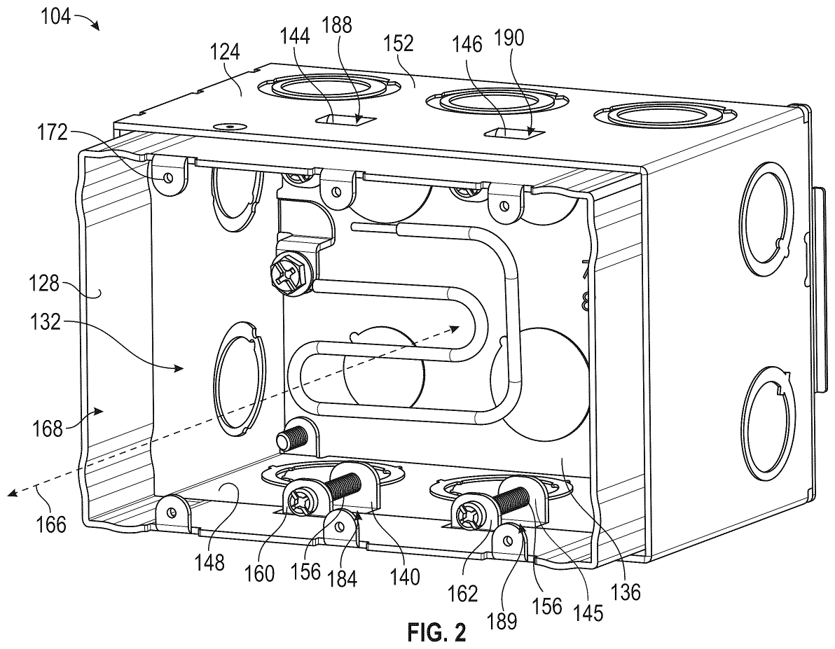

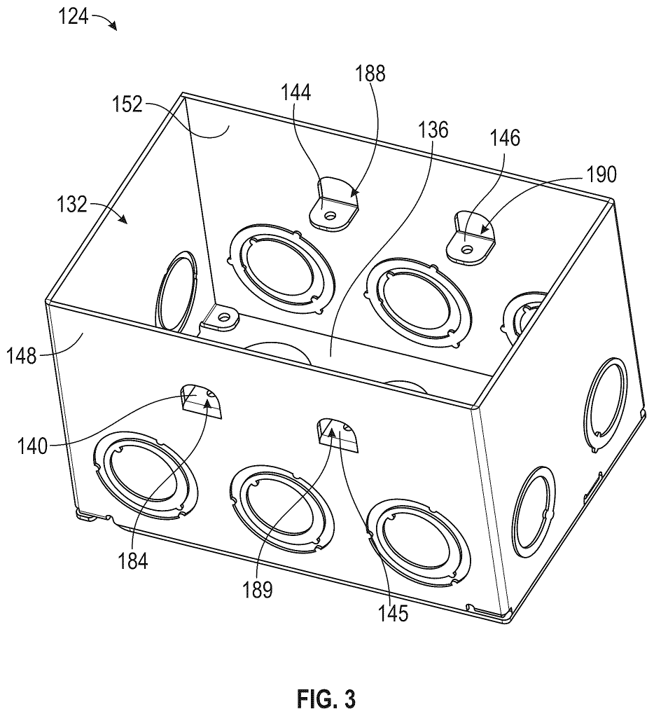

Referring to FIG. 2, the electrical box 104 includes an electrical box housing 124 and an extendable sleeve 128. The electrical box housing 124 has a front opening 132 and a rear wall 136 opposite the front opening 132. A set of housing tabs extend inward into the electrical box housing 124 from a first sidewall 148 and a second sidewall 152 (e.g., illustrated in FIG. 3 as a first housing tab 140 and a second housing tab 144). The first and second sidewalls 148, 152 may be opposing sidewalls of the electrical box 104. A first housing tab 140 may extend from the first sidewall 148, and a second housing tab 144 may extend from the second sidewall 152, so that the housing tabs 140, 144 are also on opposing sides of the electrical box 104. In some embodiments, a third housing tab 145 may extend from the first sidewall 148 and may be spaced from the first housing tab 140 in a direction that is parallel to the first sidewall 148. Likewise, a fourth housing tab 146 may extend from the second sidewall 152 and may be spaced from the second housing tab 144 in a direction that is parallel to the second sidewall 152. Although the three-device rectangular configuration of the electrical box 104 of FIG. 2 may be particularly useful in some contexts, other examples can have other shapes (e.g., round, square, octagonal etc.) and sizes (e.g., two-device, or otherwise), including as further discussed below.

In some embodiments, the first and second housing tabs 140, 144 may be directly opposite each other (i.e., an axis extending perpendicular to the first sidewall 148 may intersect or bisect both the first housing tab 140 and the second housing tab 144). Additionally, the third and fourth housing tabs 145, 146 may be positioned directly opposite each other. In other configurations, the first and second housing tabs 140, 144 (e.g., and the third and fourth housing tabs 145, 146) may not be directly opposite each other. Furthermore, as illustrated in FIG. 3 the first and second housing tabs 140, 144 can be separated from the knockouts, in a direction that extends away from the rear wall 136 (i.e., along the adjustment direction of the assembly). The separation can prevent potential interference with electrical conductors entering and leaving the electrical box 104.

The housing tabs 140, 144, 145, 146 may be configured to retain threaded adjustment fasteners 156 and permit rotation of the adjustment fasteners 156 but not translation relative to the electrical box housing 124. For example, the adjustment fasteners 156 can be rotatable relative to the housing tabs 140, 144, 145, 146 but can be translationally (axially) fixed relative to the housing tabs 140, 144, 145, 146 (e.g., via riveting or peening of the fasteners, use of E-, C-, or other clips, use of integral or removable collars, or other techniques).

Referring again to FIG. 2, the extendable sleeve 128 is configured to be received through the front opening 132 of the electrical box housing 124 and movable relative thereto. In this regard, it may be understood that the extendable sleeve 128 does not provide an extendable mud ring but is rather part of an electrical box that can itself be extended. In particular, the extendable sleeve 128 includes a set of sleeve tabs. The set of sleeve tabs may include a first sleeve tab 160, a second sleeve tab 161, a third sleeve tab 162, and a fourth sleeve tab 163.

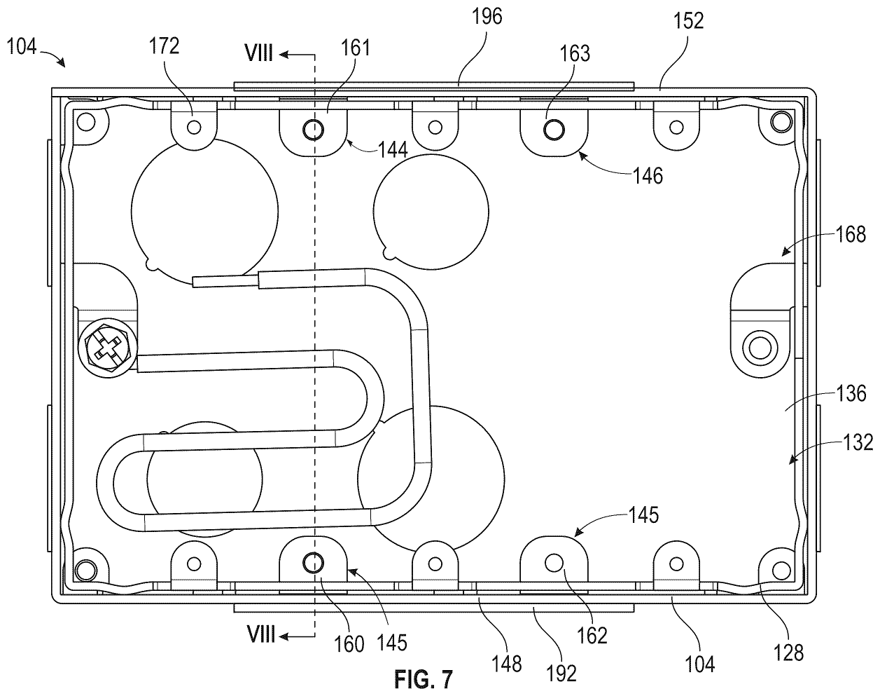

Referring briefly to FIG. 7, during assembly, respective sleeve tabs 160, 161, 162, 163 may be aligned with respective housing tabs 140, 144, 145, 146 so that respective sets of sleeve tabs and housing tabs (e.g., a set such as the first sleeve tab 160 and the first housing tab 140) can cooperatively receive an adjustment fastener 156. As such, each set of respective sleeve tabs and housing tabs includes one of the adjustment fasteners 156 extending therethrough. The sleeve tabs 160, 161, 162, 163 are threaded and configured to threadably receive the adjustment fasteners 156 so that the adjustment fasteners 156 couple the extendable sleeve 128 to the electrical box housing 124.

Referring again to FIG. 2, adjustment (e.g., rotation) of the adjustment fasteners 156 can translate the extendable sleeve 128 along an adjustment axis 166 extending perpendicularly through a center point of the rear wall 136 of the electrical box housing. The extendable sleeve 128 also includes a sleeve front opening 168 and mounting tabs 172 extending inward into the sleeve front opening 168 that are, respectively, configured to receive device fasteners (not shown) to secure electrical devices to the extendable sleeve 128 (e.g., to receive and secure electrical outlets, switches, or other known electrical devices, etc.).

Referring to FIG. 3, as discussed above, during the manufacturing of the electrical box assembly 100 it may be important to ensure proper alignment of the sets of housing tabs with the sets of sleeve tabs. To increase accuracy and precision relative to conventional approaches, the housing tabs 140, 144, 145, 146 may be integrally formed with the first and second sidewalls 148, 152. For example, the housing tabs 140, 144, 145, 146 can be stamped or otherwise cut from the first and second sidewalls 148, 152, and bent toward an inside of the electrical box housing 124. Stamping or otherwise cutting the housing tabs 140, 144, 145, 146 can be a machine-controlled process that increases placement accuracy and precision of the housing tabs 140, 144, 145, 146. Further, such an approach may not rely on a welder or other operator to estimate a fastened position or orientation of the housing tabs 140, 144, 145, 146. The housing tabs 140, 144, 145, 146 that extend integrally from first and second sidewalls 148, 152 of the electrical box housing 124 may also advantageously reduce interference with the electrical conductors entering and leaving the electrical box 104, while mitigating obstruction to the movement of the extendable sleeve 128.

Referring to FIGS. 3 and 5, in particular, stamping or otherwise cutting the first and second housing tabs 140, 144 from the first and second sidewalls 148, 152 may form holes in the first and second sidewalls 148, 152. For example, the stamping or cutting of the first and second housing tabs 140, 144 may form a first and second hole 184, 188 adjacent to the first and second housing tabs 140, 144 respectively. In this regard, for example, the tabs 140, 144 may sometimes extend integrally from an edge of the corresponding hole 184, 188 that results from formation of the tab 140, 144.

As illustrated in FIG. 3, the stamping or cutting of the first and second housing tabs 140, 144 may result in the first and second holes 184, 188 disposed on a first side of the first and second housing tabs 140, 144 nearest the front opening 132 of the electrical box housing 124 (i.e., between the tabs 140, 144 and the front opening 132). Forming the housing tabs 140, 144 such that the holes 184, 188 are disposed on the first side of the first and second housing tabs 140, 144 may reduce interference to the knockouts and other components of the housing 124 caused by the housing tabs 140, 144. For example, the housing tabs 140, 144, having the holes 184, 188 positioned on the first side of the housing tabs 140, 144, may be positioned closer to the knockouts without the holes 184, 188 potentially extending into the knockouts or a region between adjacent knockouts. Furthermore, as discussed below, covers or plates that may be used to cover the holes 184, 188 that are disposed on the first side of the first and second housing tabs 140, 144 may be positioned farther from the knockouts, thus reducing potential interference to components extending through the knockouts.

However, in other configurations, the first and second holes 184, 188 may instead be disposed on a side of the first and second housing tabs 140, 144 nearest the rear wall 136 of the electrical box housing 124 (e.g., opposite the first side). Holes may also be formed in the sidewalls 148, 152 from the stamping or cutting of the third and fourth housing tabs 145, 146, resulting in third and fourth holes 189, 190, respectively.

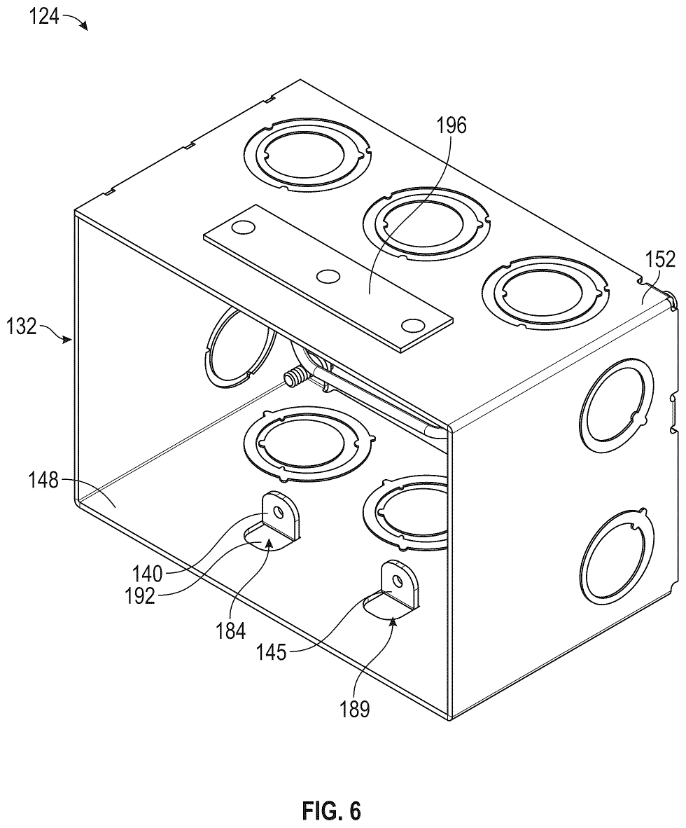

Referring to FIGS. 6 and 7, in some embodiments, the first and second holes 184, 188 may advantageously be covered to appropriately enclose the conductors (not shown) within the electrical box assembly 100. For example, applicable standards may not permit uncovered holes in sidewalls of electrical boxes. As illustrated in FIG. 6, the first and second holes 184, 188 may each be covered by a cover (e.g., a separate cover plate, a portion of a component of the assembly 100, or other cover as described further below). As will be described further below, covers may be secured to the electrical box assembly using a variety of techniques including welding (e.g., spot welding), riveting, bolting, press or friction fitting, or other known fastening techniques.

Still referring to FIG. 6, a first and second cover 192, 196 (e.g., cover plate) may contact the sidewalls 148, 152 of the electrical box housing 124 to cover or close the first and second holes 184, 188, respectively. The first and second covers 192, 196 may be welded (e.g., spot welded) to an exterior of the electrical box housing 124 to cover the first and second holes 184, 188, respectively. Spot welding the first and second covers 192, 196 to an exterior of the first and second sidewalls 148, 152 may mitigate obstruction to the movement of the extendable sleeve 128 along an interior of the electrical box housing and to electrical components within the housing.

Positioning the covers 192, 196 along an exterior of the sidewalls 148, 152 may improve access and visibility during the installation of the covers 192, 196, allowing manufacturers to attach the covers 192, 196 without hindrance from other components of the assembly 100, such as the housing tabs 140, 144, or from the need to work within the confined spaces of the inside of the housing 124. Furthermore, positioning the covers 192, 196 along an exterior of the sidewalls 148, 152 may ensure an entirety of holes 184, 188 are covered by the respective covers 192, 196, while positioning the covers 192, 196 along an interior of the sidewalls 148, 152 may be challenging due to potential obstructions caused by the housing tabs or an irregularity of a profile of the holes 184, 188 along an interior surface of the sidewalls 148, 152. However, in some embodiments, the covers 192, 196 may instead be positioned along an interior of the sidewalls 148, 152.

As shown, the first and second covers 192, 196 can be similarly sized and shaped, and discussion of either of the covers 192, 196 can correspondingly apply to the other. However, in some examples, differently sized, shaped, or otherwise configured covers (e.g., cover plates) are possible.

In some examples, the first cover 192 may extend along the first sidewall 148 to cover both the first hole 184, and the third hole 189. Likewise, the second cover 196 may extend along the second wall 152 to cover both the second hole 188 and the fourth hole 190. However, in other embodiments, the holes 184, 188, 189, 190 may each be covered by a separate cover that is spot welded, or otherwise secured, to the housing 124.

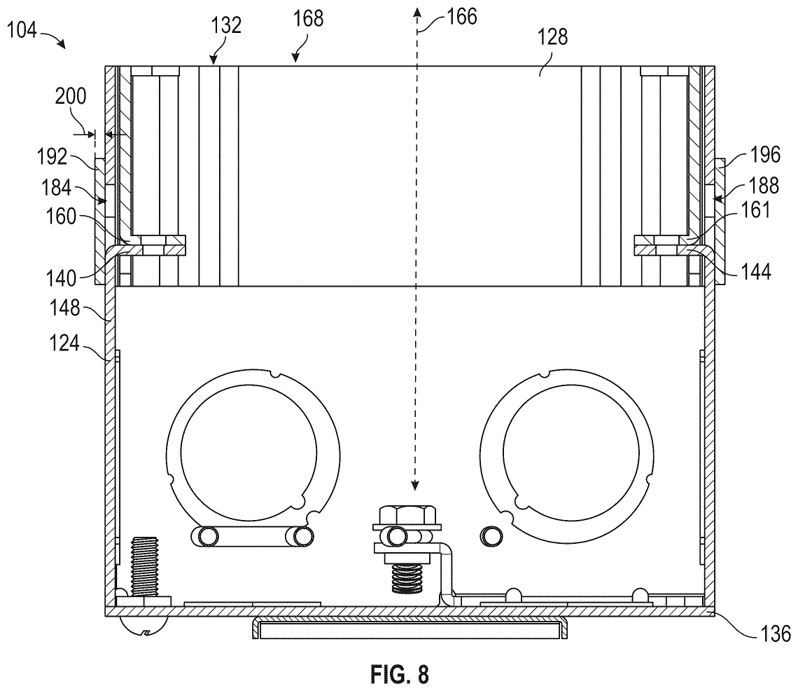

Referring to FIG. 8, in order to ensure the conductors (not shown) within the electrical box assembly 100 are properly protected, the first and second covers 192, 196 may each be a thickness 200 that is at least 0.0625 inches. For example, a cover plate having a minimum thickness of 0.0625 inches may comply with various applicable standards.

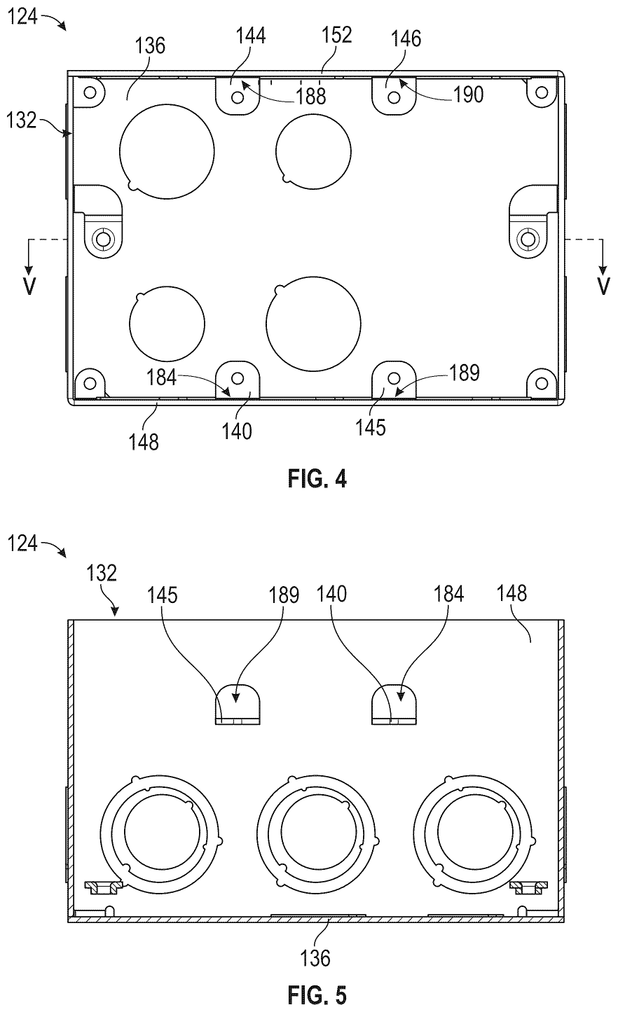

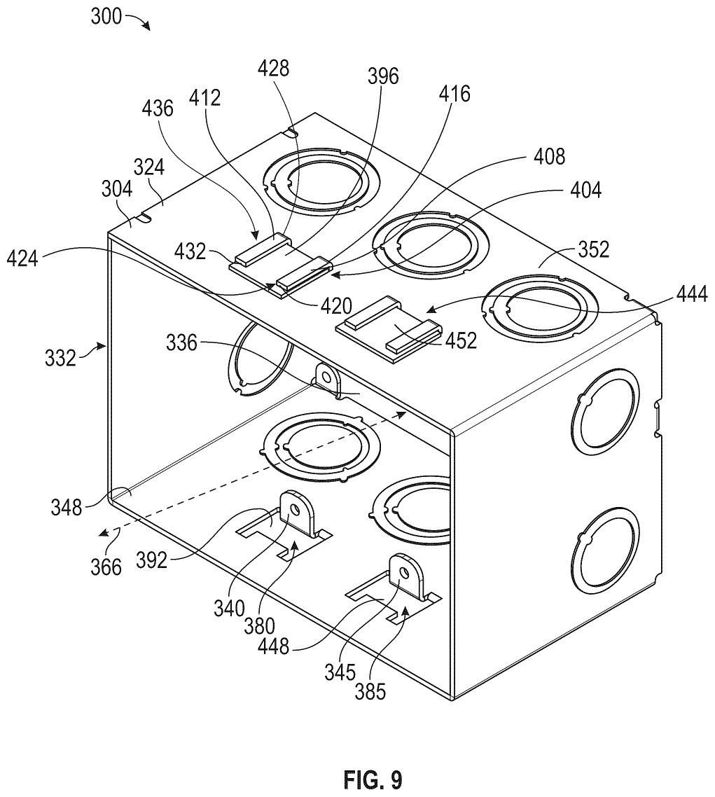

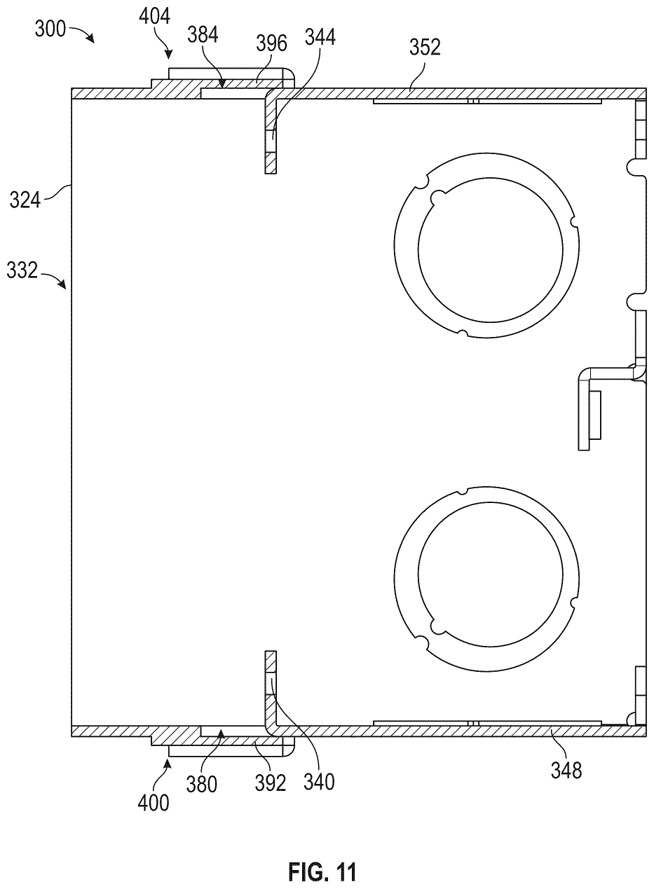

In other configurations, covers can be secured to sidewalls of an electrical box housing (and an electric box, in general) in other ways. In this regard, for example, FIGS. 9-11 illustrate another embodiment of an electrical box assembly 300. The electrical box assembly 300 of FIGS. 9-11 may generally include similar features as the electrical box assembly 100 of FIGS. 1-8, including but not limited to an electrical box 304, an electrical box housing 324, an extendable sleeve (not shown), a front opening 332, a rear wall 336, a first housing tab 340, a second housing tab 344, a third housing tab 345, a fourth housing tab 346, a first sidewall 348, a second sidewall 352, adjustment fasteners (not shown), a first sleeve tab (not shown), a second sleeve tab (not shown), a housing axis 366, a first hole 380, a second hole 384, a third hole 385, a fourth hole 386, first cover (e.g., plate) 392, and a second cover (e.g., plate) 396. Thus, discussion of the electrical box assembly 100 above also generally applies to similar components of the electrical box assembly 300 (and vice versa).

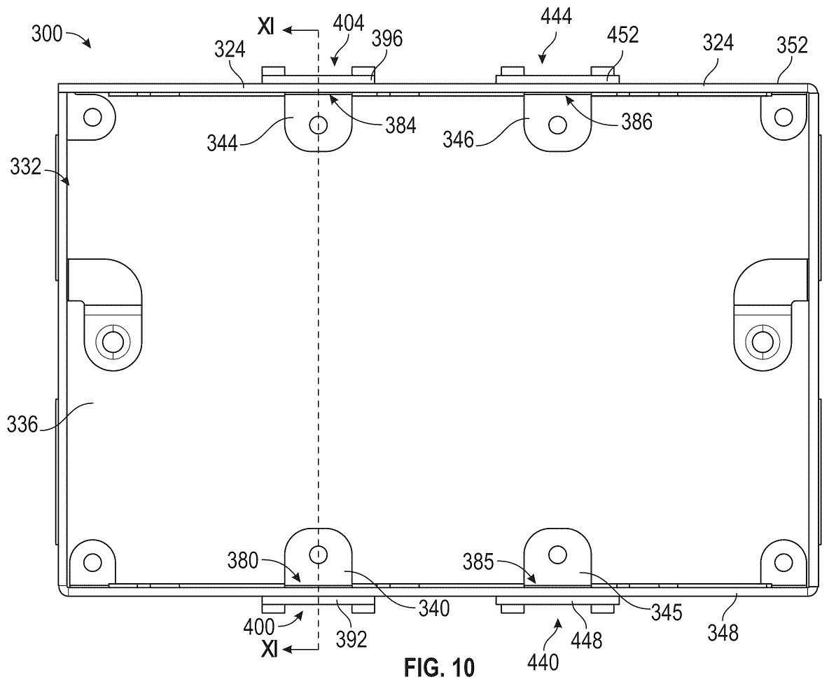

In some aspects, the electrical box assemblies 100 and 300 may differ. For example, the first and second covers 392, 396 may be secured to the electrical box housing 324 via arms that extend from the first and second sidewalls 348, 352. Referring to FIG. 9, a first set of arms 400 and a second set of arms 404 (see FIG. 10) may extend integrally from the first and second sidewalls 348, 352 respectively. The first and second sets of arms 400, 404 may mechanically secure the first and second covers 392, 396, respectively. As illustrated, the first set of arms 400 are configured similarly to the second set of arms 404, and discussion of the arms 404 thus also applies to the arms 400. In other examples, however, different sets of arms can be configured differently.

In different examples, different numbers or orientations of one or more arms can be included for particular holes on an electric box. For example, as illustrated in FIG. 9, the second set of arms 404 may include a first arm 408 and a second arm 412 that may be stamped or otherwise cut from the second sidewall 352 during the stamping or cutting of the second housing tab 344. The first arm 408 and the second arm 412 may be disposed on opposite ends of the second hole 384, and may extend in a direction that is parallel (or substantially parallel) to the housing axis 366 of the electrical box housing 324.

As illustrated in FIG. 9, the first arm 408 may extend integrally from the second sidewall 352 at a first arm end 416. The first arm 408 may extend from the first arm end 416 to a second arm free end 420 that is disconnected from the second sidewall 352. A first gap 424 may be formed between an exterior side of the second sidewall 352 and the second arm free end 420. The second arm 412 may similarly be integrally formed to extend from a third arm end 428 to a fourth arm free end 432 to form a second gap 436. The arms 408, 412 thus provide discrete channel structures into which the cover 396 can be slid (e.g., along or transverse to the housing axis 366). The second cover 396, once received into the first and second gaps 424, 436 may be secured against the second sidewall 352 by the first arm 408 and the second arm 412.

As illustrated in FIGS. 9 and 10, the first and second gaps 424, 436 may open toward a same direction as the front opening 332 of the electrical box housing 324. In other embodiments, the first and second gaps 424, 436 may alternatively open toward a direction opposite the front opening 332, or the first and second gaps 424, 436 may open in different directions.

In some embodiments, prior to receiving the second cover 396 the first gap 424 and the second gap 436 may each define a maximum width that is less than a width of the second cover 396. During installation of the second cover 396, the first arm and the second arm 408, 412 may be partially deformed (e.g., flexed elastically away from the sidewalls 348, 352) to receive the second cover 396. The deformation of the first and second arms 408, 412 may further aid the securement of the second cover 396 to the electrical box housing 324 via the resilient response of the arms 408, 412 to the deformation.

In some embodiments, the second cover 396 may be further secured by crimping or otherwise deforming the first set of arms 400 toward the second sidewall 352. Such an inward deformation of the second set of arms 404 may increase the mechanical engagement between the second cover 396, the second sidewall 352, and the second set of arms 404. Thus, for example, the deformed arms 404 may help to ensure that the second cover 396 is not unseated or otherwise moved during and after installation of the electrical box assembly 300 (e.g., as may eliminate the need for any welding of the cover 396).

In some embodiments, the first cover 392 may be secured over the first hole 380 using the first set of arms 400. The first set of arms 400 may function similarly to the second set of arms 404 described above. In some embodiments, other configurations of the first and second sets of arms 400, 404 are possible. In some embodiments, the first and second covers 392, 396 may extend to cover the third and fourth holes 385, 386 respectively, and the first and second sets of arms 400, 404 may be reconfigured accordingly (e.g., the first and second set of arms 400, 404 may include an arm positioned at either end of the first and second covers 392, 396, respectively). In some examples, third and fourth sets of arms 440, 444 (e.g., adjacent the third and fourth holes 385, 386) may cooperate with the first and second sets of arms 400, 404, respectively to secure the first and second covers 392, 396, respectively, to cover the third and fourth holes 385, 386, respectively. In other examples, the third and fourth set of arms 440, 444 may secure third and fourth covers (e.g., plates) 448, 452 to cover the third and fourth holes 385, 386, respectively. The third and fourth sets of arms 440, 444 may be shaped and may function similarly to the first and second sets of arms 400, 404.

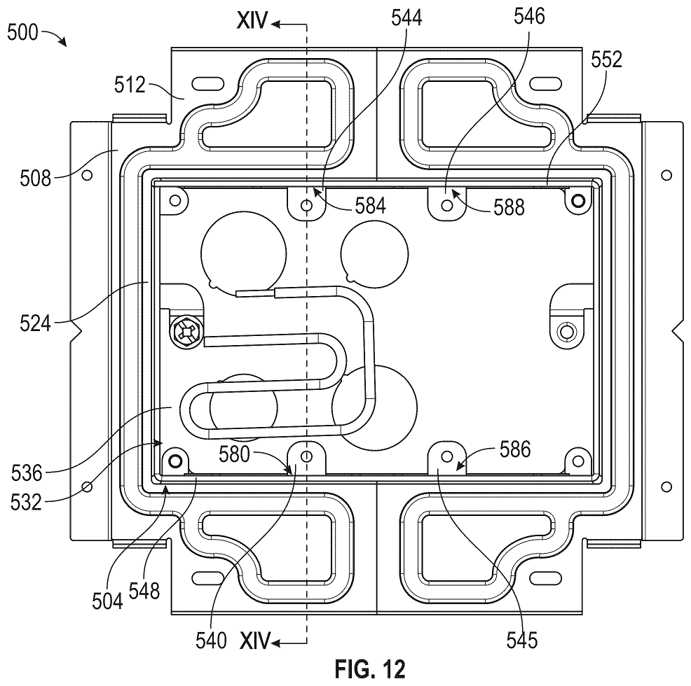

As another example, FIGS. 12-14B illustrate another embodiment of an electrical box assembly 500. The electrical box assembly 500 of FIGS. 12-14B may generally include similar features as the electrical box assembly 100 of FIGS. 1-8 including but not limited to an electrical box 504, a centerplate 508, a plate body 512, an electrical box housing 524, an extendable sleeve not shown), a front opening 532, a rear wall 536, a first housing tab 540, a second housing tab 544, a third housing tab 545, a fourth housing tab 546, a first sidewall 548, a second sidewall 552, adjustment fasteners (not shown), a first sleeve tab (not shown), a second sleeve tab (not shown), a first hole 580, a second hole 584, a third hole 586, a fourth hole 588, a first cover (e.g., plate) 592, a second cover (e.g., plate) 594, a third cover (e.g., plate) 596, and a fourth cover (not shown). Thus, discussion of the electrical box assembly 100 above also generally applies to similar components of the electrical box assembly 500 (and vice versa).

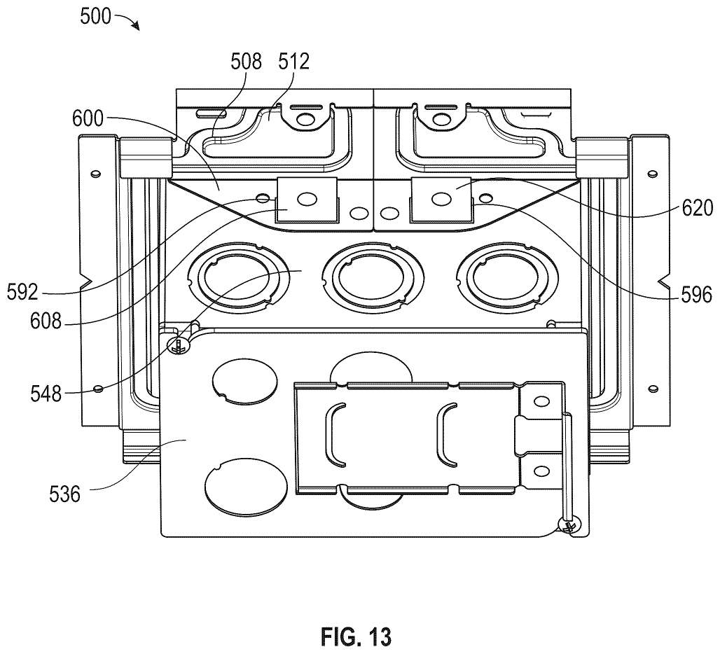

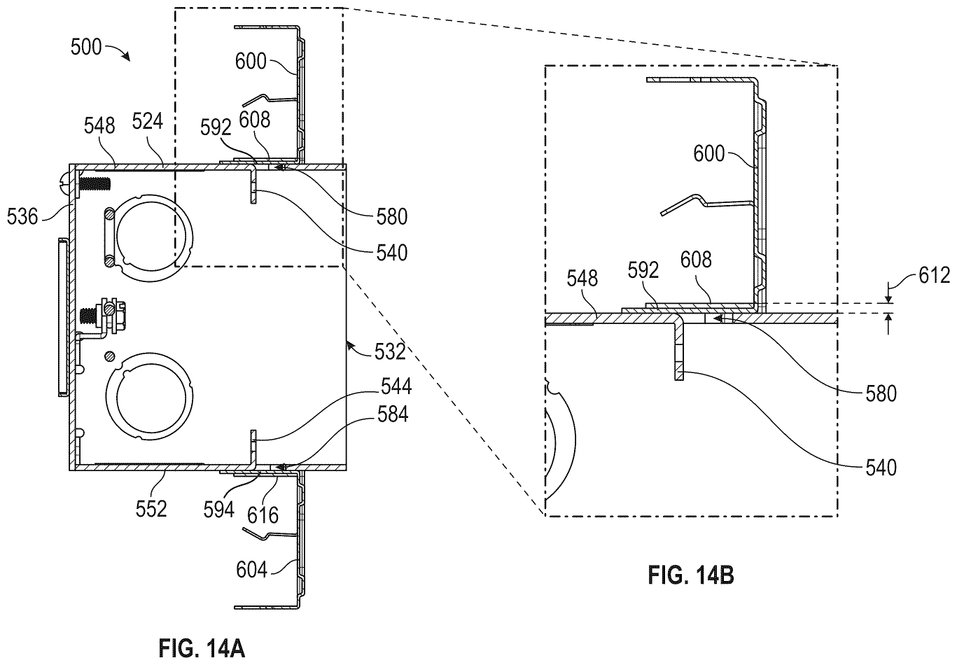

Referring to FIGS. 12 through 14, in some aspects, the electrical box assemblies 100 and 500 may differ. For example, as shown in FIGS. 14A and 14B the first and second holes 580, 584 disposed in the first and second sidewalls 548, 552, respectively, may be covered by a portion of the centerplate 508 (e.g., instead of a directly seated plate similar to the plates 392, 396 discussed above). In some embodiments, the centerplate 508 may include a set of plate arms, including at least a first plate arm 600 and a second plate arm 604. The plate arms may extend at least partially along sidewalls of the electrical box housing 524 to secure the electrical box 504 to the centerplate 508 (e.g., via various spot welds), and to at least partially surround the electrical box 504. As illustrated in FIG. 13, the first plate arm 600 may extend along an exterior of the first sidewall 548 of the electrical box housing 524. Furthermore, as illustrated in FIG. 14A, the second plate arm 604 may extend along an exterior of the second sidewall 552 of the electrical box housing 524.

Referring again to FIG. 13, in the example shown, the centerplate 508 defines a first portion and a second portion that are integrally connected and also separable by a break feature (e.g., a continuous score line as shown) so as to allow the centerplate 508 to be selectively broken into two pieces for particular installations. In other examples, a single plate arm or more than two plate arms may extend across a similar span of a box sidewall (e.g., including so as to cover one or more holes corresponding to housing tabs).

Referring to FIGS. 13 and 14A, in some examples, the first and second covers 592, 594 (e.g., cover plates) may be integral with one or more of the plate arms 600, 604. For example, focusing on the first cover 592, a region of the first plate arm 600 may define the first cover 592, and may cover or close the first hole 580. Specifically, the first cover 592 can be integrally formed with the first plate arm 600. In some examples, the first plate arm 600 may define a thickness of at least 0.0625 inches thick, such that the first cover 592 is able to properly close the first hole 580. In other examples, the region of the plate arm 600 defining the first cover 592 may be locally thickened to at least 0.0625 inches thick, while the rest of the plate arm 600 is less than 0.0625 inches thick. Similarly, the second cover 594 may define a region of the second plate arm 604, so that the second cover 594 can be integrally formed with the second plate arm 604. The second cover 594 may cover the second hole 584 and may also define a thickness that is at least 0.0625 inches thick.

In some examples, increased material thickness may be included on a plate arm of a centerplate to cover the relevant hole(s). For example, in some embodiments, the plate arms 600, 604 of the centerplate 508, and thus the first cover 592 and the second cover 594 may be less than 0.0625 inches thick. Correspondingly, in some examples, to increase a thickness of the first cover 592 and the second cover 594, a separate cover plate may be secured to the plate arms 600, 604.

Referring to FIGS. 14A-B, in some embodiments, a first cover plate 608 may be welded to the first plate arm 600 to increase a thickness of the region of the first plate arm 600 defining the first cover 592 and thus covering the first hole 580. For example, in an installed configuration, the first cover plate 608 may be situated over the first hole 580. Furthermore, in an installed configuration, the first cover plate 608 may be disposed on an opposite side of the plate arm 600 (e.g., the first cover 592) from the first outer sidewall 548. This configuration may case installation of the first cover plate 608, and may reduce obstruction between the centerplate 508 (e.g., the first plate arm 600) and the housing 524.

As illustrated in FIG. 14B, a thickness 612 of a combination of the first cover 592 of the first plate arm 600 and the first cover plate 608 may be greater than or equal to 0.0625 inches. As illustrated in FIG. 14A, the second hole 584 may similarly be covered by a combination of the second cover 594 of the second plate arm 604 and a second cover plate 616 secured to the second cover 594 (e.g., via welding), or may be otherwise configured. Additionally, the third and fourth covers (not shown in FIG. 14A) may be integrally formed or otherwise attached to the second plate arm 604. As such, the third and fourth holes 586, 588 (not shown in FIG. 14A) may be covered by a combination of the third cover 596 and the fourth cover, respectively, (not shown in FIG. 14A) and a third cover plate 620 and a fourth cover plate, respectively, (not shown in FIG. 14A) secured to the third cover 596 and the fourth cover (e.g., via welding), or may be otherwise configured.

In some configurations, locating features can be included on a centerplate for cover plates. For example, as shown in FIG. 13, U-shaped imprints or other features (e.g., embosses) can be provided to help align the cover plates 608, 616 relative to the covers 592, 594 and the plate arms 600, 604 during manufacturing.

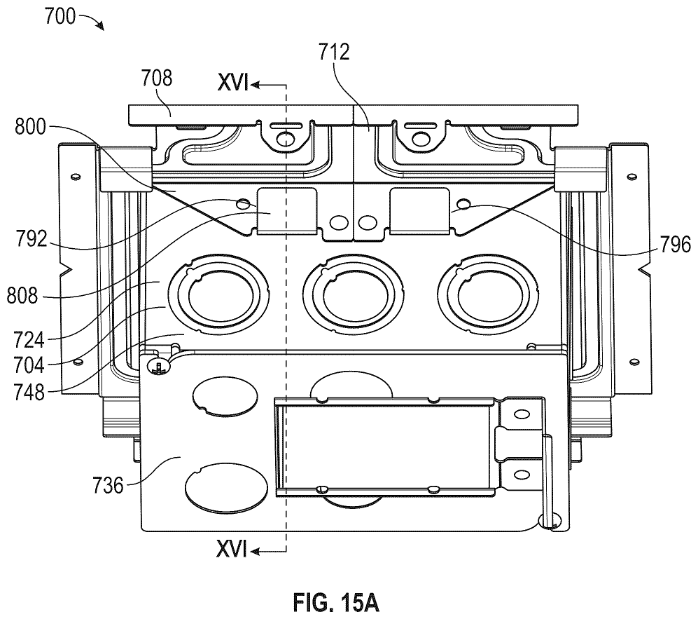

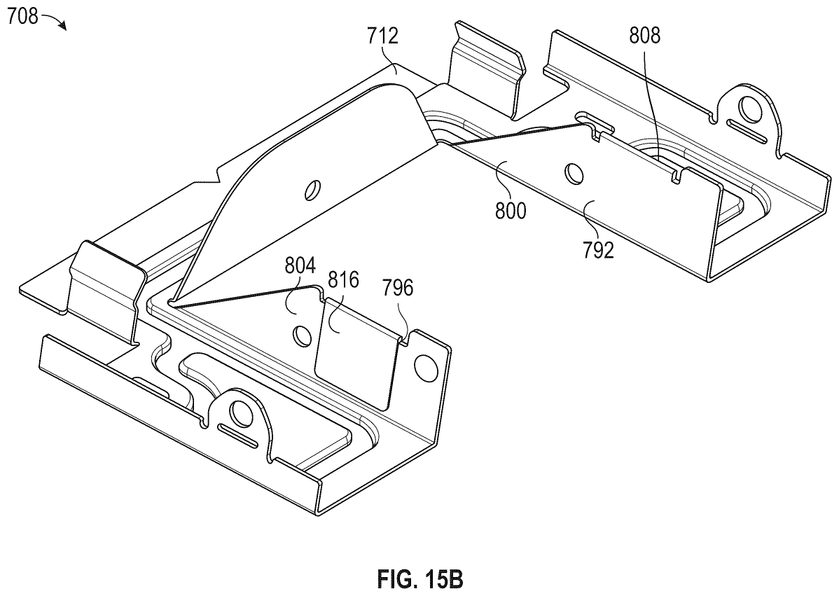

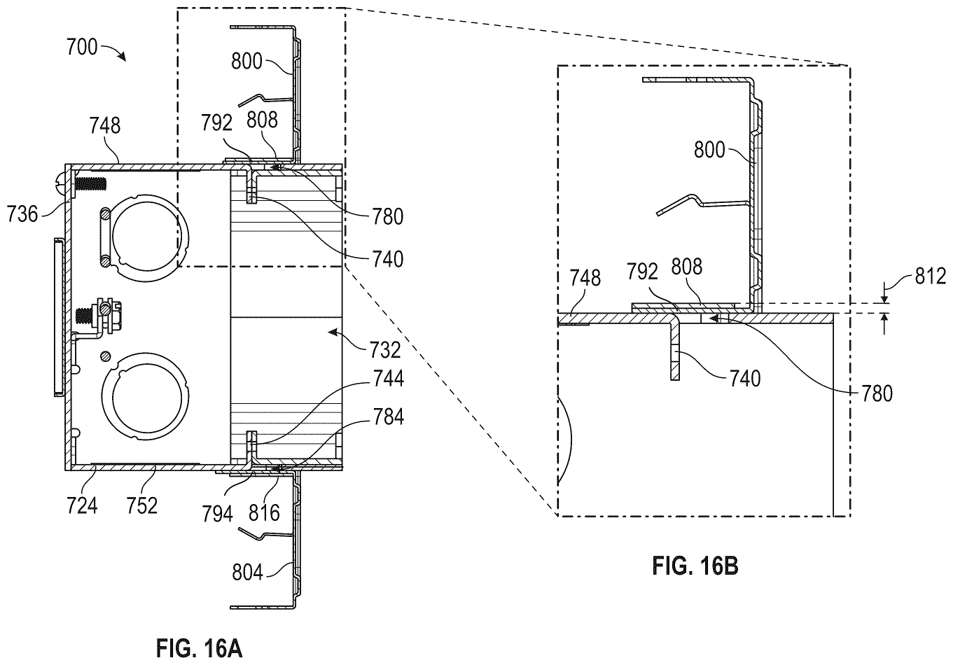

FIGS. 15-16B illustrate another embodiment of an electrical box assembly 700. The electrical box assembly 700 of FIGS. 15-16B may generally include similar features as the electrical box assembly 500 of FIGS. 12-14B, including but not limited to an electrical box 704, a centerplate 708, a plate body 712, an electrical box housing 724, an extendable sleeve (not shown), a front opening 732, a rear wall 736, a first housing tab 740, a second housing tab 744, a first sidewall 748, a second sidewall 752, adjustment fasteners (not shown), a first sleeve tab (not shown), a second sleeve tab (not shown), a first hole 780, a second hole 784, a third hole (not shown), a fourth hole (not shown), a first cover 792, a second cover 794, a third cover 796, a fourth cover (not shown), a first plate arm 800, and a second plate arm 804. Thus, discussion of the electrical box assembly 100 above also generally applies to similar components of the electrical box assembly 500 (and vice versa).

In some aspects, the electrical box assemblies 500 and 700 may differ. For example, after installation of the centerplate 708 onto the electrical box 704, the first hole 780 and the second hole (not shown) disposed in the first and second sidewalls 748, 752, respectively, may only be covered by portions of the centerplates 708 (e.g., the first cover 792 and the second cover 794). However, to increase a thickness of the first cover 792 and the second cover 794 covering the first and second holes 780, 784, respectively, the plate arms 800, 804 may include tabs that extend integrally from the plate arms 800, 804 (e.g., from the first cover 792 and the second cover 794). The tabs may accordingly be folded to cover the first and second holes 780, 784, and thereby locally increase the thickness of the covering material (i.e., so that two layers of material of the plate arms—including at least a respective one of the tabs covering each of the first cover 792 and the second cover 794—cover each of the first and second holes 780, 784) (as also shown in FIG. 15B). For example, as illustrated in FIGS. 16A-B, the first plate arm 800 may define the first cover 792 that covers the first hole 780 and a first tab 808 may be folded to cover the first cover 792 (e.g., the area of the first plate arm 800 covering the first hole 780).

As illustrated in FIG. 16B, a thickness 812 of a combination of the first cover 792 of the first plate arm 800 and the first tab 808 covering the first hole 780 may be greater than or equal to 0.0625 inches. As illustrated in FIG. 16A, the second hole 784 may similarly be covered by a combination of the second cover 794 of the second plate arm 804 and a second tab 816, or may be otherwise configured. Additionally, the third and fourth covers (not shown in FIG. 14A) may be integrally formed or otherwise attached to the second plate arm 804. As such, the third and fourth holes (not shown in FIG. 16A) may also be covered by a combination of the third cover 796 and the fourth cover, respectively, (not shown in FIG. 16A) and a third 820 and fourth tab, respectively, (not shown in FIG. 16A) that extend integrally from the second plate arm 804, or may be otherwise configured.

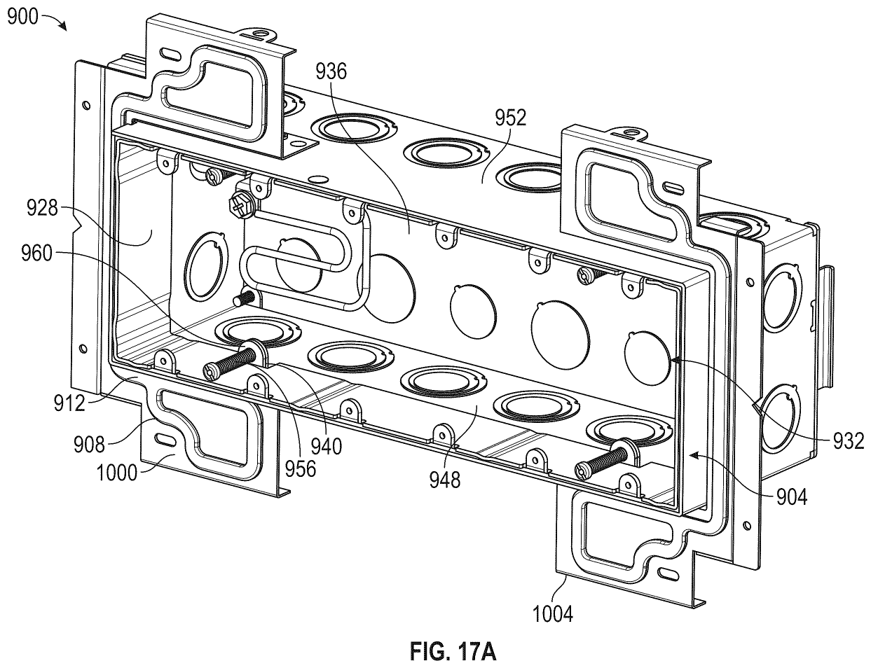

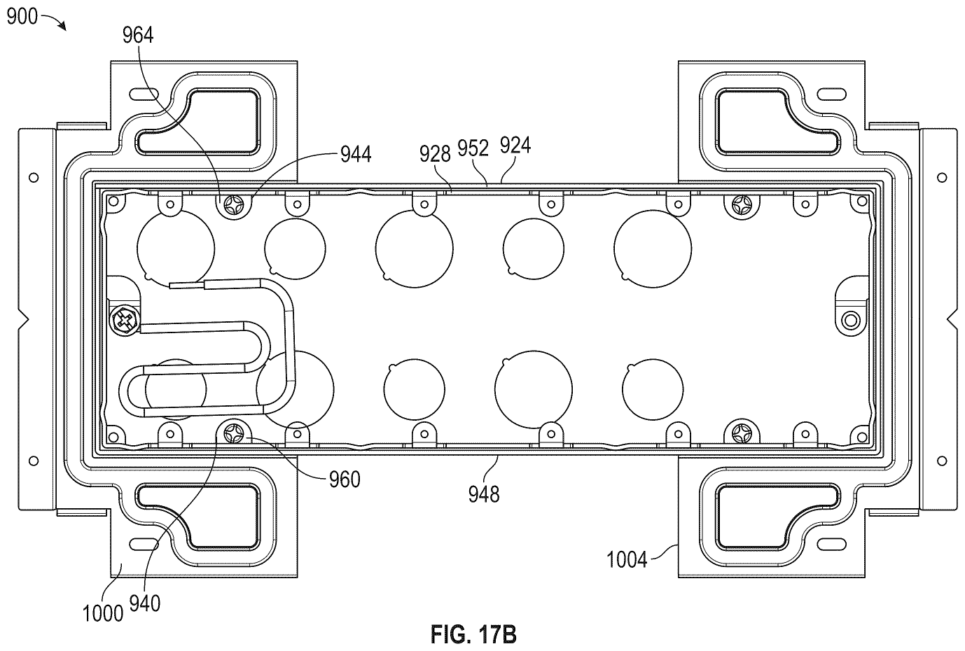

In some configurations, an electrical box assembly may include a differently configured housing or extendable sleeve to accommodate other types of electrical components (e.g., low voltage and other electrical devices, etc.) or other needs of particular installations. In this regard, for example, FIGS. 17A and 17B illustrate another embodiment of an electrical box assembly 900. The electrical box assembly 900 of FIGS. 17A and 17B may generally include similar features as the electrical box assemblies 100, 300, 500, 700 of FIGS. 1-16B, including but not limited to an electrical box 904, a centerplate 908, a plate body 912, an electrical box housing 924, an extendable sleeve 928, a front opening 932, a rear wall 936, a first housing tab 940, a second housing tab 944, a first sidewall 948, a second sidewall 952, adjustment fasteners 956, a first sleeve tab 960, and a second sleeve tab 964. Thus, discussion of the electrical box assembly 100, 300, 500, 700 above also generally applies to similar components of the electrical box assembly 900 (and vice versa).

In some aspects, the electrical box assemblies 100, 300, 500, and 700 and the electrical box assembly 900 may differ. For example, the electrical box assembly 900 of FIGS. 17A and 17B may include the electrical box housing 924 and extendable sleeve 928 that have an elongated rectangular perimeter. As above, the first sidewall 948 may include the first housing tab 940. Furthermore, the second sidewall 952 may include the second housing tab 940. As illustrated in FIGS. 17A and 17B, the electrical box housing can include four or more housing tabs. As above, a hole may be disposed adjacent to each of the four or more housing tabs. The holes of FIGS. 17A and 17B may be covered using covers (e.g., cover plates or tabs) according to any of the examples discussed above in relation to the electrical box assemblies 100, 300, 500, and 700.

In some embodiments, the centerplate 908 may be controllably breakable into two or more portions. For example, the centerplate 908 may be breakable (or be otherwise manufactured to include) a first portion 1000 and a second portion 1004. The first portion 1000 may be a first half of the centerplate 908, and the second portion 1004 may be a second half of the centerplate 908. As illustrated, the first and second portions 1000, 1004 may be substantially identical and symmetrically arranged, although other configurations are possible. Each of the first and second portions 1000, and 1004 may surround at least a portion of a perimeter of the electrical box 904 and correspondingly may cover holes in the electrical box 904 as similarly discussed above. In some examples, separate cover plates can be used to cover holes in the electrical box 904 (e.g., as also discussed above).

The discussion above is framed relative to particular electrical box assemblies and associated arrangements. However, those of skill in the art will recognize that this discussion implicitly also discloses various methods of adjustably mounting electrical boxes relative to support structures. Similarly, as also discussed above, the particular configurations of the boxes and other components expressly described and illustrated in the various embodiments are presented as examples only, and the concepts disclosed herein can be used to adjustably secure electrical boxes (or other components) relative to a variety of bracket configurations and support structures. Further, specific features discussed in detail relative to certain embodiments can be generally configured or used similarly with other embodiments, including relative to similar features on those embodiments or as substitutions or additions to those embodiments.

Thus, examples of the disclosed technology can provide improved systems for installing electrical box assemblies for suspending electrical components and fixtures. Some examples provide a depth adjustable electrical box assembly that is inexpensive to manufacture while providing an improved mechanism for aligning tabs of the electrical box that receive adjustment fasteners to adjust a depth of the electrical box.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Unless otherwise limited or defined, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive. Ranges as provide herein are inclusive of endpoints unless otherwise specified.

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive. Likewise, unless otherwise limited or defined, “substantially radial” indicates a direction that is within ±12 degrees of radial a reference direction (e.g., within ±6 degrees or ±3 degrees), inclusive. Likewise, unless otherwise limited or defined, “substantially axial” indicates a direction that is within ±12 degrees of axial a reference direction (e.g., within ±6 degrees or ±3 degrees), inclusive.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. An adjustable-depth electrical box assembly, the assembly comprising:
an adjustable-depth electrical box that includes:
a housing including:
outer sidewalls extending from a base end to an open end of the housing, the outer sidewalls including a first outer sidewall; and
a first housing tab extending integrally from the first outer sidewall, with a first hole disposed in the first outer sidewall, adjacent the first housing tab;
an extendable sleeve including sleeve walls and a first sleeve tab;
the outer sidewalls slidably receiving the extendable sleeve;
a first cover contacting an exterior of the first outer sidewall to close the first hole; and
an adjustment fastener extending through the first housing tab and the first sleeve tab and rotatable to adjust a depth of the extendable sleeve relative to the housing.

2. The assembly of claim 1, wherein the first housing tab is a stamped or cut tab and the first hole is resultant from the stamping or cutting of the first housing tab in the first outer sidewall.

3. The assembly of claim 1, wherein the first cover is a first plate secured to the exterior of the first outer sidewall.

4. The assembly of claim 3, wherein the first plate is spot welded to the first outer sidewall.

5. The assembly of claim 3, wherein the first outer sidewall further includes arms that secure the first plate against the first outer sidewall.

6. The assembly of claim 1, further comprising:
a centerplate that surrounds and supports the adjustable-depth electrical box;
wherein the first cover includes a first plate arm of the centerplate.

7. The assembly of claim 6, wherein the first cover further includes a first plate that is welded to the first plate arm on an opposite side of the first plate arm from the first outer sidewall.

8. The assembly of claim 6, wherein the first cover further includes a tab extending integrally from the first plate arm to cover the first hole.

9. The assembly of claim 1, wherein the first hole is disposed between the open end of the housing and the first housing tab.

10. The assembly of claim 1, wherein the outer sidewalls further include a second outer sidewall opposite the first outer sidewall;
wherein the housing further includes a second housing tab extending integrally from the second outer sidewall, with a second hole disposed in the second outer sidewall, adjacent the first housing tab; and
wherein a second cover contacts an exterior of the second outer sidewall to close the second hole.

11. An adjustable-depth electrical box assembly, the assembly comprising:
an adjustable-depth electrical box that includes:
a housing including:
outer sidewalls extending from a base end to an open end of the housing, the outer sidewalls including a first outer sidewall;
a first housing tab stamped from the first outer sidewall; and
a first hole resultant from the stamping of the first housing tab from the first outer sidewall;
a first cover plate contacting the first outer sidewall to close the first hole;
an extendable sleeve; and
a fastener extending through the first housing tab to adjust the extendable sleeve relative to the housing.

12. The assembly of claim 11, wherein a pair of arms extend integrally from the first outer sidewall to secure the first cover plate against the first outer sidewall.

13. The assembly of claim 11, further comprising:
a centerplate that surrounds and supports the adjustable-depth electrical box;
wherein the centerplate includes the first cover plate.

14. The assembly of claim 13, wherein the first cover plate is integral with a first plate arm of the centerplate.

15. The assembly of claim 13, wherein a second cover plate is welded to the first cover plate on an opposite side of the centerplate from the first outer sidewall.

16. The assembly of claim 13, wherein the first cover plate further includes a tab extending from the centerplate, wherein the tab is folded over to form a first layer and a second layer of the first cover plate.

17. The assembly of claim 11, wherein the first cover plate contacts an exterior surface of the first outer sidewall.

18. A method of assembling an adjustable-depth electrical box, the method comprising:
forming a housing with a housing tab integrally formed with a sidewall of the housing;
closing a hole disposed adjacent the housing tab with a cover that contacts the housing;
aligning an extendable sleeve to be inserted into the housing, so that the housing tab is aligned with a sleeve tab of the extendable sleeve; and
installing an adjustment fastener to extend through the housing tab and the sleeve tab to adjust the extendable sleeve relative to the housing.

19. The method of claim 18, wherein closing the hole includes securing the cover to the housing via one of: welding or arms extending from the housing.

20. The method of claim 18 further including, securing a centerplate to the adjustable-depth electrical box, wherein the cover includes a first plate arm of the centerplate.
